(19) United States
(12) Patent Application Publication
(10) Pub. No.: US 2006/0242667 A1
(43) Pub. Date: Oct. 26, 2006

(54) Ad monitoring and indication

(76) Inventors: Erin L. Petersen, Astoria, NY (US); Charles A. Eldering, Furlong, PA (US)

Correspondence Address: TECHNOLOGY, PATENTS AND LICENSING, INC., 2003 South EASTON ROAD, SUITE 208, DOYLESTOWN, PA, 18901, US

(21) Appl. No.: 11/112,529

(22) Filed: Apr. 22, 2005

(51) Int. Cl. H04N 7/16; H04N 7/173; G06F 13/00; H04N 5/445; G06F 3/00

(52) U.S. Cl. 725/42; 725/100; 725/131; 725/139

(57) ABSTRACT

A method and system are presented for indicating the termination of an advertisement break to a viewer. A program of interest on a first channel is determined and while the user watches other programming on alternate channels the first channel is monitored to determine when the advertisement break is over. Upon completion of the advertisement break, the viewer is notified via an on-screen icon.

### BACKGROUND

Advertisements are an inherent part of most programming and form an important revenue stream for producers of that programming. Although consumers accept the presence of advertisements in a variety of programming including audio and video entertainment programming, news, sports and other types of sponsored content, consumers also tend to look for ways in which they can avoid watching advertisements and frequently use that time for other purposes.

As an example of this consumer behavior it is frequently the case that a television viewer (subscriber) will change channels from a channel which contains a program of interest when the advertisements occur on that channel. During that time period the subscriber may leave the room or may surf the other channels and may view portions of programming on other channels while waiting for the advertisements to end on the channel containing the program of interest. Because it is not clear to the subscriber when the advertisements will end on the channel containing the program addressed, the subscriber must frequently return to that channel or risk missing part of the programming of interest when the advertisement break concludes.

What is required is a system and method for monitoring the channel containing the programming of interest and indicating to the subscriber when the advertisement break has concluded on that channel of interest, such that the subscriber can return to that channel without missing any of the programming of interest.

### SUMMARY

The method and system described herein includes the ability to determine that a program is of interest to subscriber, monitoring an advertisement break on the channel containing the program of interest and providing an indication to the subscriber that a return to programming has occurred. In one embodiment the system receives an indication from the subscriber that the channel being viewed contains a program of interest. The subscriber then moves to an alternate channel during an advertisement break that is occurring on the channel containing the program of interest. The system monitors the advertisement break on the channel containing the program of interest and determines, based on the lack of a recognizable advertisement that the advertisement break has concluded on the channel containing the program of interest. The system then displays an icon, either a visible or audible alert, or presents another indication to the subscriber thus notifying the subscriber that the program of interest is now playing on the first channel.

In one embodiment a fingerprint library is used which compares fingerprints of the signal being received on the channel containing the program of interest against a library of advertisement fingerprints to determine if the advertisement break is continuing based on the presence of known advertisements.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 illustrates a use-case diagram for the method and system for ad monitoring and indication;

FIG. 2 illustrates an activity diagram for generation of a return-to-programming indicator.

FIG. 3A illustrates a remote control containing a program-of-interest button;

FIG. 3B illustrates a television having an icon for indicating that a return-to-programming has occurred;

FIG. 4 illustrates a computer for realizing the method and system; and

FIG. 5 illustrates feature based and recognition based advertisement detection.

### DETAILED DESCRIPTION OF PREFERRED EMBODIMENTS

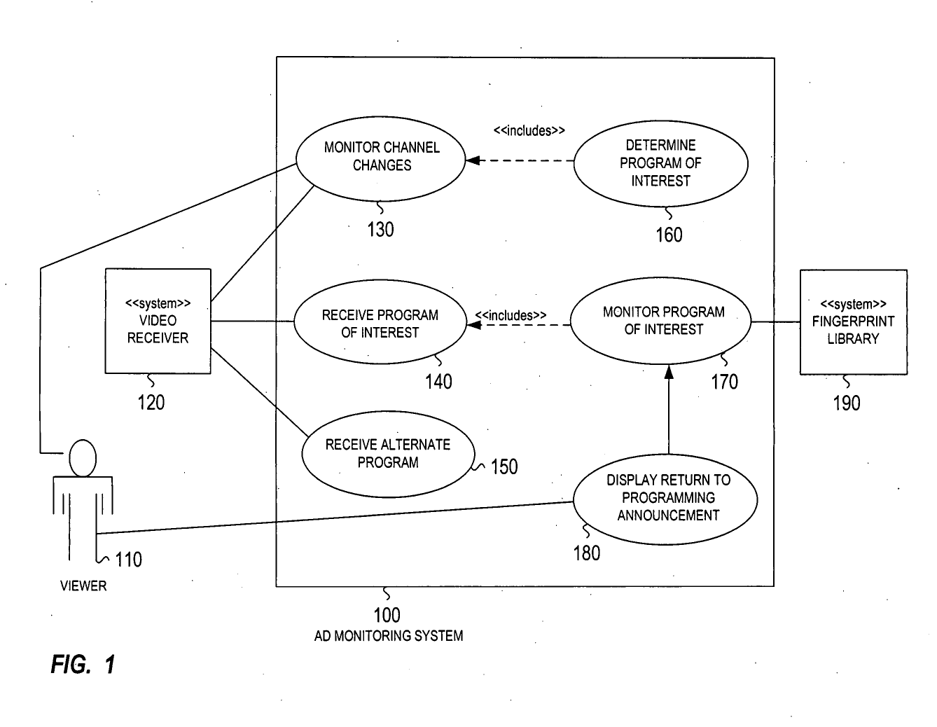

FIG. 1 illustrates a use-case diagram for an Ad Monitoring System 100. The use-case diagram is based on the use of Unified Modeling Language (UML) to describe a method and system and is not meant to limit the embodiments or implementation but is used as a tool to better describe the system architecture and operation. Referring again to FIG. 1 a Video Receiver 120 interfaces to the Ad Monitoring System 100 and within the Ad Monitoring System 100 a Monitor Channel Changes use—case 130 receives channel changes from Video Receiver 120. A Receive Program of Interest use—case 140 receives a signal from Video Receiver 120 indicating that a channel contains a program of interest. In one embodiment Viewer 110 presses a button on a remote control or other device to indicate that the current channel being viewed is a channel containing the program of interest. In this embodiment the remote control is considered to be part of Video Receiver 120 and the marking of the particular channel by Viewer 110 as a channel containing a program of interest is transmitted to the Receive Program of Interest use-case 140.

In an alternate embodiment the Ad Monitoring System 100 contains a time base, which as shown in FIG. 1 would be part of Determine Program of Interest use-case 160, which is capable of determining that Viewer 110 has remained on a particular channel for a sufficiently long period of time and determines that that channel is a channel which contains a program of interest. For example, Viewer 110 might watch a program for a period of eight minutes at which point the Ad Monitoring System 100 determines that that channel contains a program of interest, and indicates so to the Receive Program of Interest use-case 140.

Referring again to FIG. 1 Receive Alternate Program use—case 150 receives an alternate channel from Video Receiver 120. This can occur when Viewer 110 moves from the channel containing the program of interest to another channel to watch that channel while there are advertisements on the channel containing the program of interest.

A Monitor Program of Interest use-case 170 compares the incoming signal on the channel containing the program of interest against video fingerprints contained within Fingerprint Library 190. Based on the determination that the incoming video signal contains fingerprints that are recognized as advertisement fingerprints contained within Fingerprint Library 190, Monitor Program of Interest use—case 170 determines that the advertisement break is continuing on the channel containing the programming of interest. At the point at which the incoming video no longer contains fingerprints recognized to be part of advertisements or the intros or outros that sometimes preceded advertisement breaks (in countries such as the UK or Germany) a Display Return to Programming Announcement use—case 180 causes an icon, either a visual or audible alert, to be generated such that Viewer 110 has an indication that the advertisement break has concluded and that the programming is reappearing on the channel of interest.

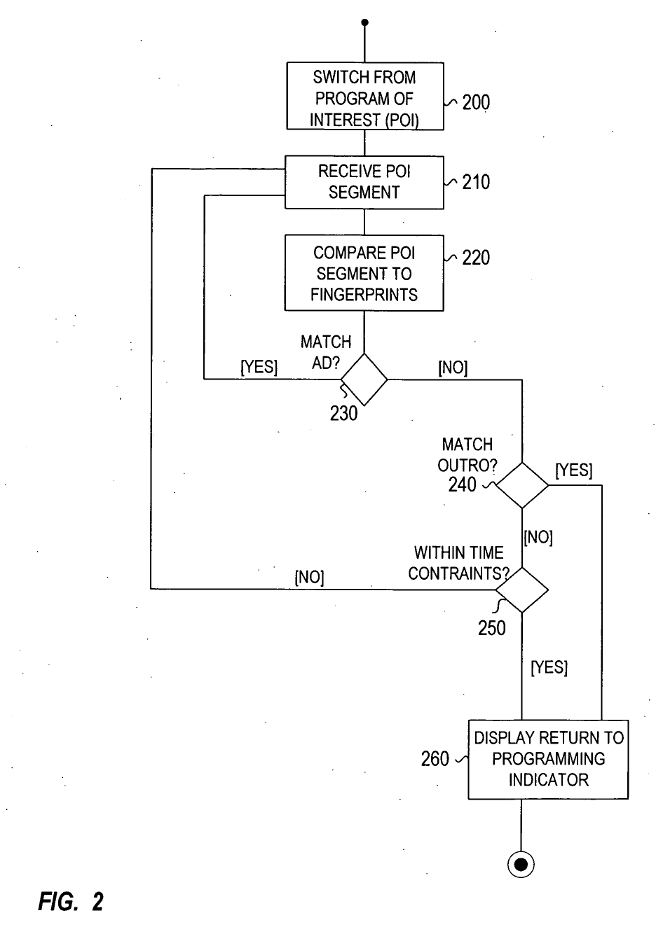

FIG. 2 illustrates an activity diagram in which a Switch from Program of Interest (POI) step 200 occurs wherein the system determines that the Viewer 110 has changed from the channel containing the program of interest. In a subsequent Receive (POI) Segment 210 step video segments are received. The received video segments are then compared against known video segments in a Compare POI Segment to Fingerprints step 220. A Match Ad test 230 is performed and in the event that the segments matched an advertisement [Yes] a return to Receive POI Segment step 210 occurs.

In the event that the received video segment does not match an ad in the fingerprint library a Match Outro test 240 is performed to determine if an outro indicating the end of the advertisement block is present. In the event that an outro is present [Yes] a Display Return to Programming Indicator step 260 is executed and the viewer is notified that the advertisement break has concluded.

In the event that any outro is not found in Match Outro test 240 it cannot be concluded that the advertisement break is over because a new ad may be present and a fingerprint for that ad may not be present in the video fingerprint library. In this case a Within Time Constraints test 250 is executed to determine if it is likely that the advertisement break has concluded based on the typical time constraints and durations for advertisement breaks. For example, if only 40 seconds has transpired since the initiation of an advertisement break it is likely that the second advertisement in the break is new and has not been recognized by the system. In this case the system may not choose to display a return to programming indicator but may instead determine that an unknown advertisement is being played and wait for a following time segment to compare a next advertisement. Because the time constraints can vary from channel to channel it is possible to estimate appropriate time constraints or expected advertisement break times based on average duration of advertisement breaks for different types of programming on different channels. In one embodiment sets of rules are created which use the electronic program guide to determine a set of timing criteria for an advertisement break.

If it is found at the Within Time Constraints test 250 that it is likely that the advertisement break has ended the Display Return to Programming Indicator step 260 is executed.

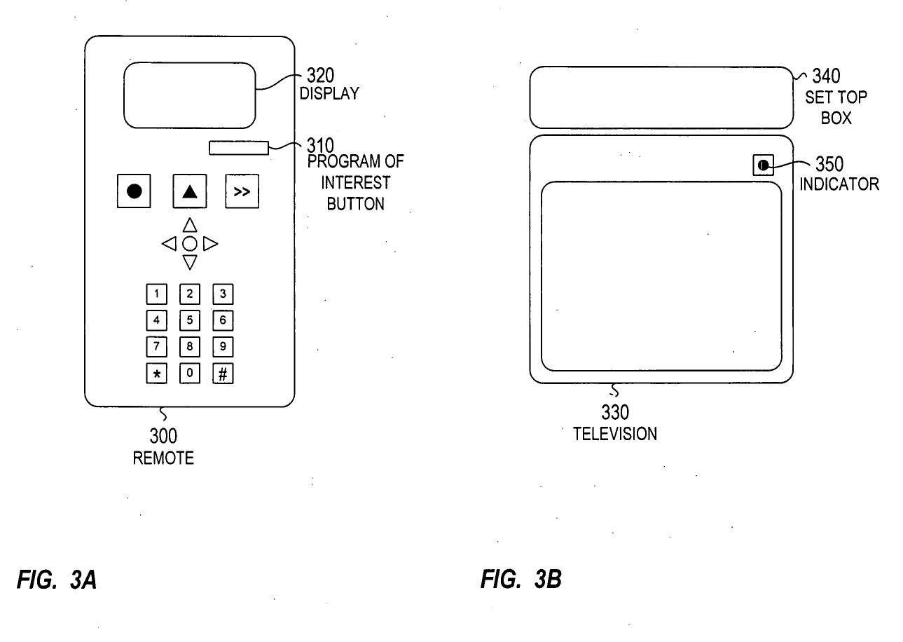

FIG. 3A illustrates a remote 300 containing a display 320 and a Program of Interest button 310. By pressing the Program of Interest button 310 or a similar button, area on the display or keyboard or other interface mechanism, the subscriber can indicate that the channel currently being viewed contains the program of interest.

FIG. 3B illustrates a television 330 in conjunction with a set-top box 340, wherein the set-top box 340 contains the capability to display and indicator 350 which indicates that a return to programming has occurred. Set-top box 340 can also contain a Personal Video Recorder (PVR) or other video receiving and recording device that is capable of receiving the channel containing the program of interest as well as alternate channels. In an alternate embodiment a computer can be utilized for the viewing of video from streaming media sources or Video on Demand (VOD) systems.

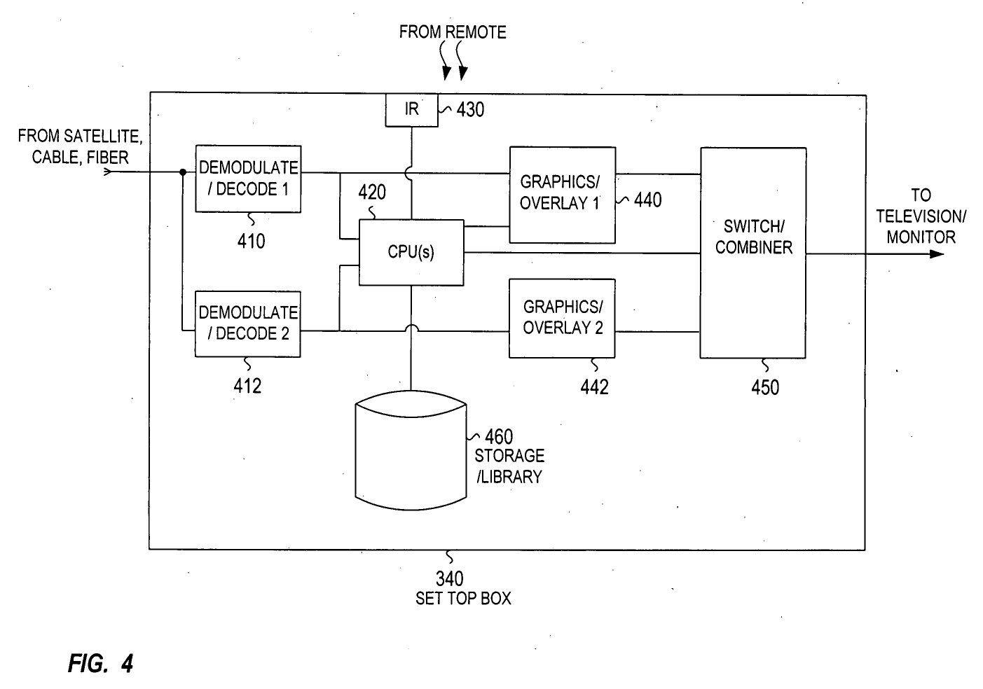

FIG. 4 illustrates an architecture for set-top box 340 in which a first demodulate/decode unit 410 receives a signal from a video source such as a satellite, cable, or fiber-optic system. A second demodulate/decode unit 412 is also present to receive one or more alternate channels. One or more Central Processing Units (CPUs) 420 are present and are utilized to compare the incoming video stream and fingerprints generated from the incoming video stream against video fingerprints contained in storage/library 460. Storage/library 460 can be a hard drive, optical storage medium, or other mass storage device. A first graphics/overlay unit 440 is present and is used to superimpose an icon onto the video display through switch/combiner 450. A second graphic/overlay unit 442 is also present and can superimpose an icon onto the alternate channel in conjunction with switch/combiner 450 which displays the programming and potentially the icon on the television/monitor.

An IR receiver 430 is also present in set-top box 340 to receive infrared signals from a remote control. As will be understood by those skilled in the art, other set-top box architectures provide the functionality for comparison of fingerprints from the incoming video stream against fingerprints in a video library, and can be utilized for the detection of advertisements or lack thereof and the insertion of icons on the display of the television/monitor to alert the subscriber to the end of an advertisement break.

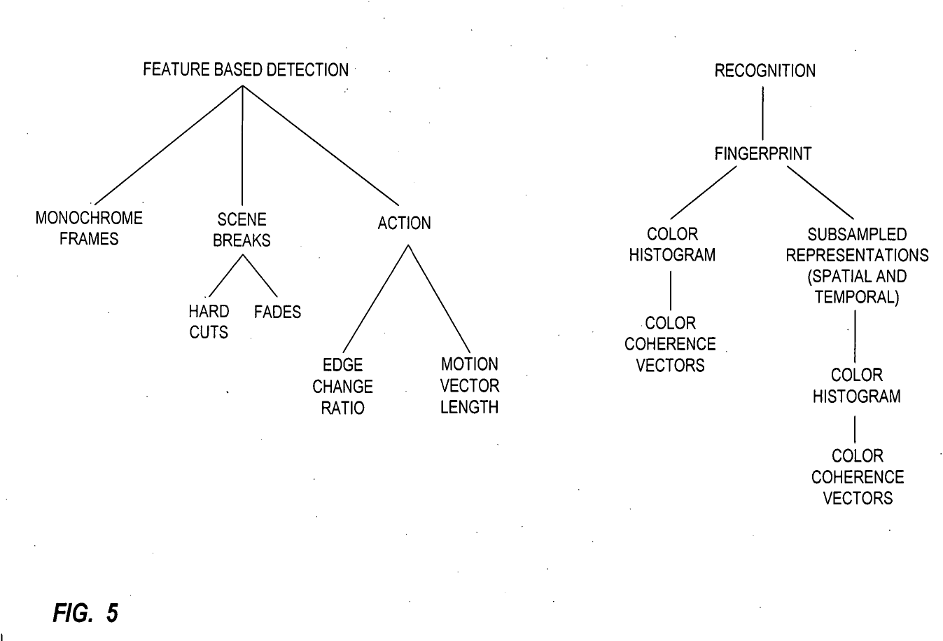

FIG. 5 illustrates the classes of feature based detection and recognition, illustrating the types of features that may be used to accomplish feature based detection and the various fingerprinting methodologies used for video sequence or segment fingerprint generation.

Referring to the left-hand side of FIG. 5 feature based detection can be accomplished utilizing a variety of features the first of which can be monochrome frames. It is well known that monochrome frames frequently appear within video streams and in particular are used to separate advertisements. Due to the presence of one or several dark monochrome frames between advertisements the average intensity of a frame or sub-frame can be monitored to determine the presence of a monochrome frame. In one embodiment multiple monochrome frames are detected to provide an indication of an ad break, set of commercials, or presence of an individual commercial. As previously discussed the presence of monochrome frames can be used to identify a candidate sequence with subsequent fingerprint recognition being utilized to determine the presence of individual advertisements. In this embodiment the presence of the monochrome frames are not used to make a final determination regarding the presence of advertisements but rather to identify a candidate sequence.

Referring again to the left-hand side of FIG. 5 scene breaks may be utilized to identify candidate sequences. Within the category of scene breaks both hard cuts and fades commonly occur in advertisements as well as occurring at the point at which programming ends and at which advertisements begin. Detection of hard cuts can be accomplished by monitoring color histograms, the statistics regarding the number of pixels having the same or similar color, between consecutive frames. Histogram values can be monitored for a candidate sequence or within the subsequence. A sequence having a hard cut frequency that is considered above average is a sequence likely to contain advertisements. Fades, which are the gradual transitions from one scene to another, are characterized by having a first or last frame the exhibits a standard intensity deviation that is close to zero. The transition from a scene to a monochrome frame and into another scene, characteristic of a fade, can be identified by a predictable change in intensity and in particular by monitoring standard intensity deviation. Because fade patterns have a characteristic temporal behavior (the standard intensity deviation varying linearly or in a concave manner with respect to time or frame number) the standard deviation of the intensity can be calculated and criteria established which are indicative of the presence of one or more fades.

With respect to action based feature detection, action within a video sequence, including action caused not only by fast-moving objects but by hard cuts and zooms or changes in colors, can be detected by monitoring edge change ratio and motion vector length. Edge change ratio can be monitored by examining the number of entering and exiting edge pixels between images. Monitoring the edge change ratio registers structural changes in the scene such as object motion as well as fast camera operations. Edge change ratio tends to be independent of variations in color and intensity, being determined primarily by sharp edges and changes in sharp edges and thus provides one convenient means of identifying candidate sequences that contain multiple segments of unrelated video sequences.

Motion vector length is useful for the determination of the extent to which object movement occurs in a video sequence. Motion vectors typically describe the movement of macro blocks within frames, in particular the movement of macro blocks within consecutive frames of video. In one embodiment compressed video such as video compressed by Motion Picture Expert Group compliant (MPEG) video compressors has motion vectors associated with the compressed video stream. Commercial block sequences or video segments containing a large number of scene changes and fast object movement are likely to have higher motion vector lengths.

Referring again to FIG. 5 recognition of video segments sequences or entities can be accomplished through the use of fingerprints, the fingerprints representing a set of statistical parameterized values associated with an image or a portion of an image from the video sequence segment or entity. One example of a statistical parameterized value that can be used as a base for fingerprint is the color histogram of an image or portion of an image. The color histogram represents the number of times a particular color appears within a given image or portion of an image. The color histogram has the advantage of being easy to calculate and is present for every color image.

The Color Coherence Vector (CCV) is related to the color histogram in that it presents the number of pixels of a certain color but additionally characterizes the size of the color region those pixels belong to. For example the CCV can be based on the number of coherent pixels of the same color, with coherent being defined as a connected region of pixels, the connected region having a minimum size (e.g. 8×8 pixels). The CCV is comprised of a vector describing the number of coherent pixels of a particular color as well as the number of incoherent pixels of that particular color.

Fingerprint generation can be accomplished by looking at an entire image to produce fingerprints or by looking at sub-sampled representations. A sub-sampled representation may be a continuous portion of an image or regions of an image which are not connected. Alternatively, temporal sub-sampled representations may be utilized in which portions of consecutive frames are analyzed to produce a color histogram or CCV. In an alternate embodiment the frames analyzed are not consecutive but are periodically or aperiodically spaced. Utilization of sub-sampled representations has the advantage that full processing of each image is not required, images are not stored (potentially avoiding copyright issues), and processing requirements are reduced.

As an example of an industrial use of the method and system described herein the system can be implemented on a set-top box, computer or PVR and allows a subscriber to surf off of a channel containing a program of interest to alternate channels while advertisements are being displayed on the channel containing the program of interest. While the subscriber is viewing alternate programming and potentially surfing through various channels the set-top computer or PVR is monitoring the channel containing the programming of interest to determine if the advertiser break has finished. In addition to matching incoming video segments against known advertisements, timing rules may be present to provide an indication in conjunction with the matching of the video fingerprints, as to if the advertisement break is complete.

In describing various embodiments illustrated in the drawings, specific terminology will be used for the sake of clarity. However, the embodiments are not intended to be limited to the specific terms so selected, and it is to be understood that each specific term includes all technical equivalents which operate in a similar manner to accomplish a similar purpose.

It is noted that any and/or all of the above embodiments, configurations, and/or variations of the present invention described above can be mixed and matched and used in any combination with one another. Moreover, any description of a component or embodiment herein also includes hardware, software, and configurations which already exist in the prior art and may be necessary to the operation of such component(s) or embodiment(s).

All embodiments of the present invention, can be realized in on a number of hardware and software platforms including microprocessor systems programmed in languages including (but not limited to) C, C++, Perl, HTML, Pascal, and Java, although the scope of the invention is not limited by the choice of a particular hardware platform, programming language or tool.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

The many features and advantages of the invention are apparent from the detailed specification. Thus, the appended claims are to cover all such features and advantages of the invention that fall within the true spirit and scope of the invention. Furthermore, since numerous modifications and variations will readily occur to those skilled in the art, it is not desired to limit the invention to the exact construction and operation illustrated and described. Accordingly, appropriate modifications and equivalents may be included within the scope.

What is claimed is:

1. A computer-based method for indicating that a channel has returned to programming after an advertisement break comprising:
determining a program of interest to a subscriber;
monitoring an advertisement break on the channel containing the program of interest;
determining that an advertisement break has concluded on the channel containing the program of interest based on the lack of recognizable advertisement; and
displaying an indication that a return to programming has occurred.

2. The method of claim 1 wherein the determining a program of interest to the subscriber occurs through a subscriber selection.

3. The method of claim 1 wherein the determining a program of interest to the subscriber occurs based on a time duration associated with the viewing of the channel containing the program of interest.

4. The method of claim 1 wherein the determining that an advertisement break has concluded on the channel containing the program of interest based on the lack of recognizable advertisement is accomplished by use of advertisement fingerprint matching.

5. The method of claim 1 wherein the displaying occurs through a screen-displayed icon.

6. The method of claim 5 wherein the screen-displayed icon is displayed over programming on an alternate channel being viewed wherein the alternate channel does not contain the programming of interest.

7. A system for determining when an advertisement break has ended on a channel containing programming of interest comprising:
a program of interest monitoring system for receiving an indication that a channel is the channel containing programming of interest;
a channel monitoring system for determining that an alternate channel not containing the programming of interest is being viewed;
an advertisement monitoring system for monitoring the channel containing programming of interest to determine if a recognizable advertisement is present;
a display system for generating a message indicating that the channel containing programming of interest has returned to programming due to the lack of recognizable advertisement.

8. The system of claim 7 wherein the advertisement monitoring system further contains an advertisement fingerprint library for comparison of advertisements on the channel containing programming of interest to known advertisements.

9. The system of claim 8 wherein the fingerprint library receives periodic updates.

10. The system of claim 9 wherein the program of interest monitoring system for receiving an indication that a channel is the channel containing programming of interest further contains a receiver for receiving a command indicating that the channel is the channel containing programming of interest.

11. The system of claim 9 wherein the program of interest monitoring system for receiving an indication that a channel is the channel containing programming of interest further contains a time base for determining that a channel being viewed is the channel containing programming of interest.

12. A system for indicating that a channel has returned to programming after an advertisement break comprising:
means for determining a program of interest to a subscriber;
means for monitoring an advertisement break on the channel containing the program of interest while the subscriber is viewing an alternate channel;
means for determining that an advertisement break has concluded on the channel containing the program of interest based on the lack of recognizable advertisement; and
means for displaying an indication that a return to programming has occurred.

13. The system of claim 12 wherein the means for determining a program of interest to the subscriber includes a sub-system for receiving a subscriber selection indicating the program of interest.

14. The system of claim 12 wherein the means for determining a program of interest to the subscriber contains a time base for measuring the amount of time a channel is viewed and for determining that after a sufficient time being viewed the channel contains the program of interest.

15. The system of claim 12 wherein the means for determining that an advertisement break has concluded on the channel containing the program of interest based on the lack of recognizable advertisement includes an advertisement fingerprint library.

16. The method of claim 12 wherein the means for displaying includes an on-screen icon display system.

17. The method of claim 16 wherein the on-screen display system includes an overlay system for displaying the icon over programming on the alternate channel.
